(19) United States
(12) Patent Application Publication
(10) Pub. No.: US 2002/0155762 A1
(43) Pub. Date: Oct. 24, 2002

(54) Terminal/pin block for multipin electronic plug

(75) Inventors: Thorsten Lau, Meinerzhagen (DE); Gert Krah, Kirchen (DE); Heinz Sonntag, Zirndorf (DE)

Correspondence Address: THE FIRM OF KARL F ROSS, 5676 RIVERDALE AVENUE, PO BOX 900, RIVERDALE (BRONX), NY, 10471-0900, US

(73) Assignee: ELCO Europe GmbH

(21) Appl. No.: 10/125,683

(22) Filed: Apr. 18, 2002

(30) Foreign Application Priority Data
Apr. 19, 2001 (DE) 10119412.9

(51) Int. Cl. H01R 13/502

(52) U.S. Cl. 439/701

(57) ABSTRACT

A terminal/pin block for making a multipin electronic plug has a rigid dielectric plate lying in a plane and having a pair of edges and two opposite faces. Respective centering formations formed on the faces project away from the plane and the centering formations of one of the faces are complementary to and fittable in the centering formations of the other of the faces. A row of conductive strips imbedded in the plate all lie in a common plane parallel to each other and each have one end forming a contact pin and an opposite end forming a terminal. The contact pins all extend from one of the edges of the plate and the terminals all extend from another of the plate edges.

### FIELD OF THE INVENTION

The present invention relates to a multipin electronic plug of the type used, for instance, on a computer-printer cable. More particularly this invention concerns a block that carries a single row of pins associated with respective terminals and that is used in the manufacture of such a plug.

### BACKGROUND OF THE INVENTION

A standard multipin electronic plug has a body with several rows of pins that fit into respective conductive holes of a complementary socket. Each pin is associated with a respective terminal to which a wire or printed-terminal contact is soldered. Two rows of terminals are normally used, although a greater number of rows is employed in special situations.

The basic element for making such a multipin electronic plug is a terminal/pin block having a rigid dielectric plate lying in a plane and having a pair of edges and two opposite faces and a row of conductive strips imbedded in the plate. The strips all lie in a common plane parallel to each other and each have one end forming a contact pin and an opposite end forming a terminal. The contact pins all extend from one of the edges of the plate and the terminals all extend from the other of the plate edges. Each pin end is slim and of uniform shape and section, and each terminal end often has a wire- or solder-holding split. The strips may be straight or nonstraight, for instance L-shaped, when the terminals project crosswise to the pins.

Such a terminal/pin block is made by first stamping out of sheet metal the row of conductive strips with flashing left between them to maintain their spacing. This stamped-out part is then cast into a plastic plate from which the terminal and pin ends project, the flashing being provided at the projecting portions. Then the flashing is punched out, leaving the strips fixed in the plate but electrically isolated from each other.

To make the multipin plug, at least two such terminal/pin blocks are encased in a mold and positioned therein such that the pins and terminals are at the desired orientation relative to one another. Then more plastic is injected in to form around the plates a larger plastic body from one edge of which projects several rows of pin ends and from another edge of which project several rows of terminal ends.

The problem with this style of manufacture is that the terminal/pin blocks often shift during the final molding operation so that the pins become misaligned and cannot fit a standard plug. This misalignment is normally caused by the high pressure of the plastic injected in a high-speed operation into the final mold so that, even if the blocks are perfectly positioned as the mold is closed, the incoming resin displaces them during the molding operation.

### OBJECTS OF THE INVENTION

It is therefore an object of the present invention to provide an improved terminal/pin block for a multipin electronic plug.

Another object is the provision of such an improved terminal/pin block for a multipin electronic plug which overcomes the above-given disadvantages, that is which can be manufactured at high speed without producing misaligned contact pins.

A further object is to provide an improved method of making a multipin electronic plug.

### SUMMARY OF THE INVENTION

A terminal/pin block for making a multipin electronic plug has a rigid dielectric plate lying in a plane and having a pair of edges and two opposite faces. According to the invention respective centering formations formed on the faces project away from the plane and the centering formations of one of the faces are complementary to and fittable in the centering formations of the other of the faces. A row of conductive strips imbedded in the plate all lie in a common plane parallel to each other and each have one end forming a contact pin and an opposite end forming a terminal. The contact pins all extend from one of the edges of the plate and the terminals all extend from another of the plate edges.

The method of this invention therefore involves the steps of embedding in the above-defined rigid dielectric plate the row of conductive strips with the strips all lying in the plane parallel to each other and with the pins extending from one plate edge and the terminals from the other. Each of the faces of the plate is formed with at least one respective centering formation projecting away from the plane with the centering formations of one of the faces complementary to and fittable in the centering formation of the other of the faces. A plurality of the plates are stacked with the pins extending parallel to each other and the formations of adjacent plates interfitting and impeding movement of the plates relative to each other parallel to the plane. Then the stacked plates are enclosed in a mold cavity with the pins and terminals outside the mold cavity, and the mold cavity is filled around the plates with a molten dielectric plastic that is hardened into a plug body.

The centering formations according to the invention prevent any shifting of the blocks during the molding operation.

Thus in the finished product the pins and terminals will be perfectly positioned.

According to the invention the plate is generally square and has four corners and the formations are at the corners. Furthermore the formations of the other face are formed as seats into which the centering formations of the one face can fit for stacking of the blocks. These formations have planar outer end faces extending parallel to the plane.

### BRIEF DESCRIPTION OF THE DRAWING

The above and other objects, features, and advantages will become more readily apparent from the following description, reference being made to the accompanying drawing in which:

FIG. 1 is a top view of the terminal/pin block according to the invention;

FIG. 2 is a section taken along line II-II of FIG. 1; and

FIG. 3 is a largely schematic view illustrating the method of this invention.

### SPECIFIC DESCRIPTION

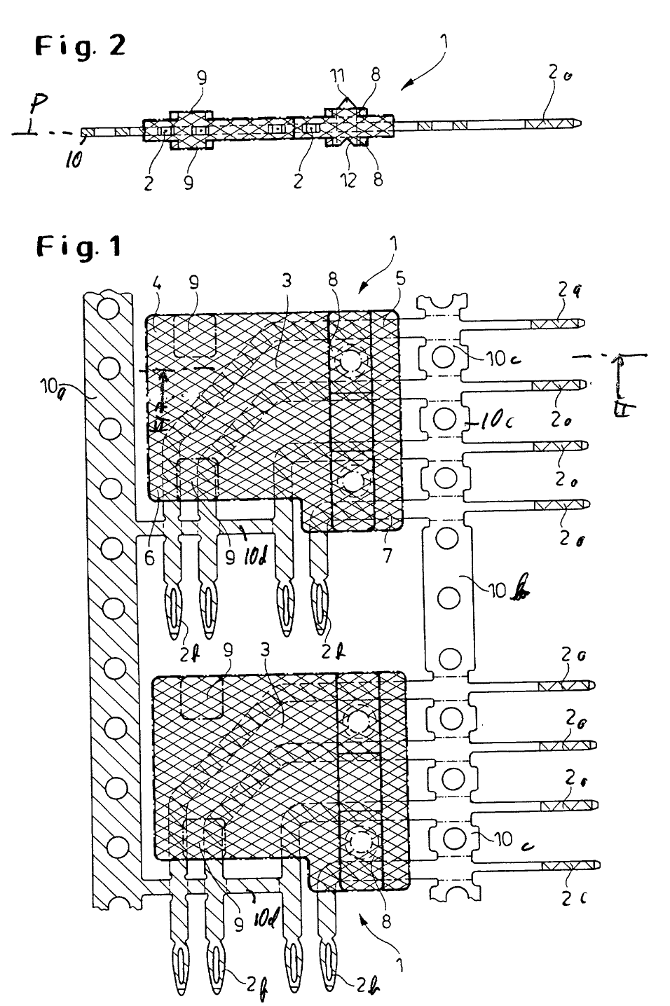

As seen in FIGS. 1 and 2, terminal/pin blocks 1 are made according to the invention by stamping from conductive sheet metal rows of L-shaped conductive strips 7 each having one end forming a contact pin 2a and an opposite end forming a terminal 2b. The pins 2a extend parallel to one another in a plane P and the terminals 2b extend at a right angle to the pins 2a, but also parallel to one another and in the same plane P. Initially flashing 10c interconnects the pins 2a of each block 2b, flashing 10b connects the pins 2a of one block 1 with the adjacent block, flashing 10d interconnects the terminals 2b of each block 1 together, and flashing 10a connects the flashing 10d of each block 1 with the flashing 10d of adjacent block(s) 1.

A generally square plate 3 of dielectric plastic is cast around the row of conductive strips 7 for each block 1, with the pins 2a, terminals 2b, and all the flashing 10a, 10b, 10c, and 10d, outside the edges of the plates 3. There is no electrical contact between adjacent strips 7 inside each plastic plate 3.

According to the invention each plate 3 has four corners 4, 5, 6, and 7. A rectangular-section bar 8 is formed on each face of each plate 3, projecting perpendicular to the plane P and extending generally between the corners 5 and 7 and parallel to the edge extending between these corners 5 and 7 and from which the pins 2a project. The bar 8 on one face is formed with a pair of upstanding conical centering formations or bumps 11 and the bar 8 on the opposite face is formed with a pair of complementary conical centering formations or seats 12. In addition near each corner 4 and 6, each plate 3 is formed on each face with a pair of square bumps 9 of the same height as the respective bars 8 so that the outer faces of the bars 8 and bumps 9 on the faces of each plate 3 lie on planes symmetrically flanking and parallel to the plane P.

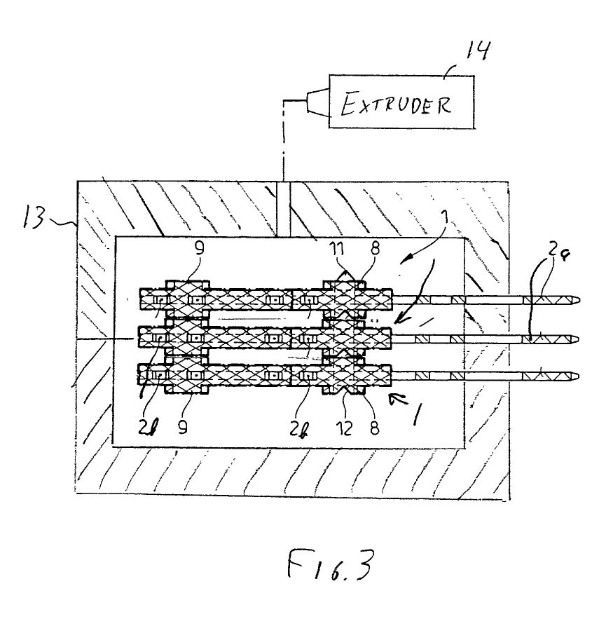

In order to fashion the blocks 1 into a multipin electronic plug, after the plates 1 have cured all the flashing 10a, 10b, and 10d is punched out to leave the conductors 7 of each plate 3 insulated from each other and to separate the blocks 1 from one another. Then as shown in FIG. 3 the blocks 1 are stacked up directly atop one another with the bumps 11 of each block 1 engaging in the seats 12 of the adjacent block 1. This interfit ensures that they blocks 1 remain exactly positioned relative to each other. The same effect could be achieved by formations 8 and 9 of different shape, for instance as a pin and socket or groove and ridge.

This stack is then enclosed in a cavity of a mold 13 with the pins 2a and terminals 2b projecting from the mold 13. An extruder 14 pressurizes the mold 13 around the blocks 1 with molten resin. After this resin cures, the plug is demolded. Since the plates 3 are prevented from shifting parallel to each other by the engagement of the bumps 11 in the seats 12, the pins 2a will be perfectly positioned. Since the raised centering formations 8 and 9 do not occupy or constitute the entire faces of the plates 3, the incoming resin can flow between adjacent plates 3 and form a solid matrix for them.

It is possible to sandwich plates 3 without conductive strips 7 between adjacent plates 3 having such strips 7 in order to make a blank row, or to clip off the pins 2a and terminals 2b for the same effect.

We claim:

1. A terminal/pin block for making a multipin electronic plug, the block comprising:
a rigid dielectric plate lying in a plane and having a pair of edges and two opposite faces;
respective centering formations formed on the faces and projecting away from the plane, the centering formations of one of the faces being complementary to and fittable in the centering formations of the other of the faces; and
a row of conductive strips imbedded in the plate, all lying in a common plane parallel to each other, and each having one end forming a contact pin and an opposite end forming a terminal, the contact pins all extending from one of the edges of the plate and the terminals all extending from the other of the plate edges.

2. The terminal/pin block defined in claim 1 wherein the plate is generally square and has four corners, the formations being at the corners.

3. The terminal/pin block defined in claim 1 wherein the formations of the other face being formed as seats into which the centering formations of the one face can fit for stacking of the blocks.

4. The terminal/pin block defined in claim 1 wherein the formations have planar outer end faces extending parallel to the plane.

5. A method of making a multipin plug, the method comprising the steps of:
embedding in a rigid dielectric plate lying in a plane and having a pair of edges and two opposite faces a row of conductive strips with the strips all lying in the plane parallel to each other and each having one end forming a contact pin projecting from one of the edges and an opposite end forming a terminal extending from the other of the edges;
forming on each of the faces of the plate a respective centering formation projecting away from the plane with the centering formations of one of the faces complementary to and fittable in the centering formation of the other of the faces;
stacking a plurality of the plates with the pins extending parallel to each other and the formations of adjacent plates interfitting and impeding movement of the plates relative to each other parallel to the plane;
enclosing the stacked plates in a mold cavity with the pins and terminals outside the mold cavity; and
filling the mold cavity around the plates with a molten dielectric plastic and hardening the plastic around the plates into a plug body.
